(19) United States
(12) Patent Application Publication
(10) Pub. No.: US 2006/0235064 A1
(43) Pub. Date: Oct. 19, 2006

(54) Method of protecting a soybean plant with flutriafol

(75) Inventors: Robert Andrew Noon, Farnham (GB); Terrance Lane Baker, Ocean Grove, NJ (US); Mauricio Leonardo van Santen, Parana (BR)

Correspondence Address: PILLSBURY WINTHROP SHAW PITTMAN, LLP, P.O. BOX 10500, MCLEAN, VA, 22102, US

(73) Assignee: Cheminova A/S, Lemvig (DK)

(21) Appl. No.: 11/387,982

(22) Filed: Mar. 24, 2006

Related U.S. Application Data
(60) Provisional application No. 60/664,715, filed on Mar. 24, 2005.
(60) Provisional application No. 60/690,898, filed on Jun. 16, 2005.

(51) Int. Cl. A01N 43/64

(52) U.S. Cl. 514/383

(57) ABSTRACT

This invention relates to a method of protecting a soybean plant or the seed from which it is grown from foliar diseases, such as rust diseases, using the compound flutriafol. This invention also relates to a method of protecting a plant from soybean rust diseases using the compound flutriafol.

This application claims priority under 35 U.S.C. § 119(e) to U.S. Provisional Application No. 60/664,715, filed on Mar. 24, 2005, and U.S. Provisional Application No. 60/690,898, filed on Jun. 16, 2005, both of which are herein incorporated by reference in their entirety.

### FIELD OF THE INVENTION

The present invention relates to a new method of protecting plants from foliar diseases using the compound flutriafol.

### BACKGROUND

A severe threat to soybean-growing farmers is a rust disease commonly known as soybean rust or Asian rust. While once limited to Asia and Australia, soybean rust has now spread worldwide. The United States, in particular, became infected in the autumn of 2004, probably through hurricane winds that brought the fungus from South America. As the world's largest producer of soybeans, the United States faces a significant threat to soybean crops from this rapidly spreading disease.

Soybean rust appears on the leaves of growing plants and causes the plants to experience premature defoliation, poor pod filling, smaller seed production and lower yields, as well as other detrimental effects. While it is known that certain chemicals have been effective in controlling rust diseases on certain plants, treatments using the chemicals have generally been limited to foliar applications, i.e. spraying the leaves of the growing soybean plants with the chemical. This method of application requires special equipment and machinery for spraying, not to mention significant time and labor. Additionally, a few weeks after application, a further spray is normally necessary as the effects of the first spray breakdown. In fact, more than two sprays may be required during the growing season to protect the soybean plant effectively. Thus, foliar application is both expensive and burdensome.

A cheaper and more environmentally friendly alternative to foliar application is application of a fungicide to the seed prior to sowing or to the soil at the time of sowing. This involves applying a fungicide to a seed or to the soil near the seed at the time when the seed is planted, allowing the fungicide to be absorbed into the seed at an early stage of plant development. Fungicides have been used in seed applications to control seed-borne and soil-borne fungi and those diseases that affect germination, emergence and early establishment of the plant. However, for diseases that occur at more mature stages in a plant's life, such as foliar diseases, application of fungicides to the seed of the plant has generally not been successful for two main reasons: (1) the low concentration of fungicide used when administered to the seed is typically insufficient to provide adequate protection of the plant by the time a foliar disease occurs; and (2) if higher concentrations of fungicide are used on the seed, it is generally believed that the higher concentrations will cause phytotoxicity in the plants, leading to germination, seedling emergence, and seedling development problems.

Thus, what is needed in the art is an inexpensive and environmentally friendly method of protecting plants from foliar diseases using a fungicide that can be effectively administered to the seed of the plant. This invention answers that need.

### SUMMARY OF THE INVENTION

It has now surprisingly and unexpectedly been found that flutriafol shows a remarkably prolonged effect in the control of foliar diseases on plants when applied to the seed or to the soil surrounding the seed at sowing. Flutriafol is a highly systemic fungicide that is transported in the xylem tissue. This high systemicity means that flutriafol is able to protect against diseases appearing in mature plants, such as rust diseases. It has also surprisingly and unexpectedly been found that flutriafol can be applied to the seed in an amount that is both effective for treating foliar diseases and does not cause phytotoxicity.

Accordingly, this invention relates to a method of protecting a soybean plant from a foliar disease comprising applying a composition containing an effective amount of flutriafol to a soybean seed or to the soil from which the soybean seed grows prior to, during, or immediately after the sowing of the seed. The invention also relates to a method of protecting a plant from soybean rust disease comprising applying a composition containing an effective amount of flutriafol to the seed of a plant capable of being infected with soybean rust or to the soil from which the seed grows prior to, during, or immediately after the sowing of the seed.

### DETAILED DESCRIPTION OF THE INVENTION

One aspect of the invention relates to a method of protecting a soybean plant from a foliar disease. The method comprises applying a composition containing an effective amount of flutriafol to a soybean seed or to the soil from which the soybean seed grows prior to, during, or immediately after the sowing of the seed.

Flutriafol, with its very high systemicity can be effectively used to protect soybean plants from foliar diseases. Foliar diseases, as is well known in the art, are diseases that infect the leaf blades of plants, causing lesions on the leaves. The foliar disease may be a rust disease, such as the soybean rusts, which are caused by the fungi Phakopsora pachyrhizi and Phakopsora meibomiae. Flutriafol can also be effectively used as a protectant against other fungal diseases found in soybean.

As used herein, a soybean plant includes all known soybean plants and all known varieties, including genetically modified plants. A soybean plant seed includes all known soybean plants seeds and all known seed varieties, including genetically modified seeds.

Another aspect of this invention relates to a method of protecting a plant from soybean rust disease. The method comprises applying a composition containing an effective amount of flutriafol to the seed of a plant capable of being infected with soybean rust or to the soil from which the seed grows prior to, during, or immediately after the sowing of the seed.

While soybean plants can be infected with rusts, the same fungi can also infect other plants including several known species of legumes, Korean and Japanese clover, white clover, kidney beans, garden pea, ornamental plants such as hyacinth bean, and wild hosts such as kudzu, crown-vetch, and yellow sweet clover.

Flutriafol, a well-known fungicidally active compound, is a member of the triazole group of fungicides. The IUPAC name of flutriafol is (RS)-2,4′-difluoro-α-(1H-1,2,4-triazol-1-ylmethyl)benzhydryl alcohol. The chemical structure of the compound is reproduced below: 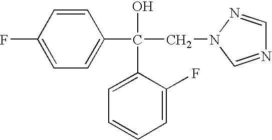
Flutriafol is sold commercially as a fungicide by Cheminova under the trade names Impact® and TOPGUARD® (liquid formulations), Vincit® (seed treatments) and Atout® (granular formulations). Methods of manufacturing flutriafol and a description of the compound may be found in U.S. Pat. No. 4,551,469 (as compound 46), herein incorporated by reference in its entirety.

The flutriafol composition may be applied to the soil from which the seed grows prior to, during, or immediately after the sowing of the seed. When applied immediately after the sowing of the seed, the composition should be applied no later than the time at which the seed establishes a root system in the soil. For example, the flutriafol composition may be applied on or about the time that the seed is planted, as an in-furrow application. Application at a significantly later point in time, for instance at the point when the seed has become a mature plant with leaves, is outside the desired time frame, as the opportunity to introduce the composition into the root system of the plant at an early stage has since elapsed. When the flutriafol composition is applied to the soil from which the seed grows, the composition may be directed into the soil mixing zone below the level of the top of a furrow in which the seed may be planted. In this way, the composition may be incorporated in the soil below the level of the soil, on the seed, above the seed, and to the side of the seed as the furrow is closed. Particularly beneficial results have been seen when the composition is directed to areas of the soil in which the roots from the seed are likely to spread. The roots, when contacted with the soil containing the composition, absorb the composition, and then distribute the composition throughout the plant through known means.

The flutriafol composition may also be used as a seed treatment, i.e. applying the composition to the seed as a coating or otherwise. The composition may be applied to the seed in a seed treatment at any time from the harvesting of the seed to the sowing of the seed. The flutriafol composition may be applied using methods including but not limited to mixing in a container, mechanical application, tumbling, spraying, and immersion. For a general discussion of techniques used to apply fungicides to seeds, see “Seed Treatment,” 2d ed., (1986), edited by K. A. Jeffs (chapter 9), herein incorporated by reference in its entirety. The composition may be applied to the seed using tumbler devices, which act as cement mixers when applying the composition to the seed. Alternatives include purpose-designed machinery that uniformly distributes chemical onto seed contained within a rotating mixing vessel. Such applications may be performed in batch or continuous flow processes.

While the above methods relate to applying the flutriafol composition to the soil from which the seed grows or to the seed as a coating, additional methods of using flutriafol to protect plants may be used in conjunction with these methods. For instance, after the seeds and/or soil has been treated with the flutriafol composition, additional flutriafol treatments may be applied to the resulting plant through foliar applications or otherwise. Foliar sprays are typically applied at the R1 (beginning bloom) and/or R2 (full bloom) stages, and if necessary, also at the R3 (beginning pod) stage. The foliar sprays may be applied as an additional prophylactic treatment prior to evidence of infection, or as a therapeutic treatment, applied at the first signs of active soybean rust (or other foliar disease) on the leaves of the plant.

As used herein, an amount of the composition effective to provide protection to the plant against damage caused by fungi is the lowest amount of flutriafol that will provide such protection. When applied to the soil from which the seed grows, the flutriafol composition may be applied an amount ranging from about 2 to about 375 grams flutriafol per hectare of soil; preferably, the amount ranges from about 10 to about 250 grams flutriafol per hectare of soil; and most preferably, the amount ranges from about 30 to about 125 grams flutriafol per hectare of soil. When applied to the seed, the flutriafol composition may be applied in an amount ranging from about 1 to about 100 grams flutriafol per 100 kilograms of seed; preferably, the amount ranges from about 1 to about 25 grams flutriafol per 100 kilograms of seed; and most preferably, the amount ranges from about 3 to about 15 grams flutriafol per 100 kilograms of seed.

The composition containing flutriafol may also contain one or more fertilizers or nutrients to promote growth of the seed once planted. The fertilizers may be mixed or incorporated into the composition containing flutriafol, used with the flutriafol composition as a separate component, or used independently of the flutriafol composition in a separate application on the soil. Suitable fertilizers include organic and inorganic nitrogen-containing compounds such as urea, urea-formaldehyde condensation products, amino acids, ammonium salts and nitrates; potassium salts (preferably chlorides, sulphates, nitrates); and phosphoric acid and/or salts of phosphoric acids (preferably potassium salts and ammonium salts). The fertilizers may also contain salts of micronutrients (preferably manganese, magnesium, iron, boron, copper, zinc, molybdenum and cobalt) and phytohormones (e.g. vitamin B1 and indole-III-acetic acid). The fertilizer is generally used in amounts ranging from about 1 to about 200 kilogram fertilizer per hectare of soil, preferably in amounts ranging from about 10 to about 150 kilogram fertilizer per hectare of soil. The use of fertilizers in the composition may also serve to impregnate/absorb the flutriafol to create solid fertilizer carrier material, e.g. fertilizer granules containing the flutriafol. Generally, when used in this manner, the fertilizer compositions containing the flutriafol should contain from 0.0001 to 95% by weight flutriafol, preferably 0.1 to 90%.

The flutriafol composition may optionally contain fungicides, bactericides, acaricides, nematicides or insecticides. Like the fertilizers, the additional fungicides, bactericides, acaricides, nematicides, and insecticides may be mixed or incorporated into the composition containing flutriafol, used with the flutriafol composition as a separate component, or used independently of the flutriafol composition in a separate application on the soil.

Suitable fungicides include strobilurin-type fungicides (e.g. azoxystrobin, dimoxystrobin, famoxadone, fenamidone, fluoxastrobin, kresoxim-methyl, metominostrobin, picoxystrobin, pyraclostrobin and trifloxystrobin) imidazole/triazole fungicides (e.g. azaconazole, bitertanol, bromuconazole, cyproconazole, difenoconazole, fenbuconazole, fluquinconazole, flusilazole, hexaconazole, imazalil, ipconazole, metconazole, myclobutanil, paclobutrazol, penconazole, propiconazole, prochloraz, prothioconazole, tebuconazole, tetraconazole, triadimefon, triadimenol, triticonazole, uniconazole, and epoxiconazole), chloronitrile fungicides (e.g. chlorothalonil), and carboxamide fungicides (e.g. boscalid). Particularly preferred fungicides include captan, fludioxonil, prochloraz, thiram, carboxin, maneb, mancozeb, pentachloronitrobenzene, metalaxyl, benomyl, thiabendazole, thiophanate-methyl, and carbendazim.

Suitable insecticides include cypermethrin, terbufos, imidacloprid, thiamethoxam, clothianidin, fipronil, chlorpyrifos, bifenthrin, acephate, carbofuran, tebupirimfos, tefluthrin, aldicarb, benfuracarb, cadusafos, carbosulfan, oxamyl, fenamiphos, and diazinon. Diazinon is known to control seedcorn maggots in soybean plants. Preferred insecticides include diazinon and imidacloprid.

The composition containing the flutriafol may be applied as any type of agrochemically acceptable composition. The composition may be in a liquid form, such as an emulsifiable concentrate, a dispersion, a suspension concentrate, or aqueous emulsion; in a solid form, such as powders, dusts, pellets, or granules; or in a paste, wettable powder, or water-dispersible granules. Generally, it is preferred that when the composition is applied to the soil from which the seed grows, it is applied as solid or granulate composition. When the composition is applied to the seed, it is generally preferred that the composition be applied as a liquid composition. However, these preferences lie in the convenience of application, and no disadvantage is seen from applying the composition in another argochemically acceptable form.

To prepare emulsions, pastes or oil dispersions, the flutriafol composition can be homogenized in water or dissolved in an oil or solvent by means of wetting agents, adhesives, dispersants or emulsifiers, as known in the art. Concentrates containing the flutriafol, wetting agent, adhesive, dispersant or emulsifier, and possibly solvent or oil can also be prepared which are suitable for dilution with water. Powder, scattering, and dusting compositions may be prepared by mixing or joint grinding the flutriafol with a solid carrier.

Granules, for example coated, impregnated and homogeneous granules, may be prepared by binding the flutriafol to solid carriers through known methods. Solid carriers include mineral earths, such as silica gel, silicic acids, silicates, talc, kaolin, limestone, lime, chalk, bole, loess, clay, dolomite, diatomaceous earth, calcium sulfate and magnesium sulfate, magnesium oxide, ground synthetic materials, fertilizers, such as ammonium sulfate, ammonium phosphate, ammonium nitrate, ureas and vegetable products, such as cereal flour, tree bark meal, wood meal and nutshell meal, and cellulose powder. Examples of granular formulations include Cheminova's ATOUT® and IMPACT® 1.5 G products.

The composition containing the flutriafol may be prepared in any known manner, such as with solvents, carriers, emulsifiers, dispersants, surface-active agents, or a combination thereof. Suitable solvents include aromatics (e.g. xylene), chlorinated aromatics (e.g. chloroben-zenes), paraffins (e.g. petroleum fractions), alcohols (e.g. methanol, butanol), ketones (e.g. cyclohexanone), amines (e.g., ethanolamine, dimethylformamide) and water. If water is used as a diluent, other organic solvents may be used as the solvents. Suitable carriers include ground natural minerals (e.g. kaolins, aluminas, talc, chalk) and ground synthetic minerals (e.g. highly disperse silica, silicates). Suitable emulsifiers include nonionic and anionic emulsifiers (e.g. polyoxyethylene fatty alcohol ethers, alkylsulfonates and arylsulfonates). Suitable dispersants include lignin-sulfite waste liquors and methylcellulose. Suitable surface-active agents include alkali metals, alkaline earth metals, ammonium salts of aromatic sulfonic acids, (e.g. lignosulfonic, phenolsulfonic, naphthalenesulfonic and dibutylnaphthalenesulfonic acid), fatty acids, alkyl- and alkylarylsulfonates, alkyl-, lauryl ether and fatty alcohol sulfates, salts of sulfated hexa-, hepta- and octadecanols, fatty alcohol glycol ethers, condensation products of sulfonated naphthalene and its derivatives with formaldehyde, condensation products of naphthalene or of the naph-thalenesulfonic acids with phenol and formaldehyde, polyoxyethylene octylphenol ether, ethoxylated isooctyl-, octyl- or nonylphenol, alkylphenol or tributyl-phenylpolyglycol ethers, alkylaryl polyether alcohols, isotridecyl alcohol, fatty alcohol ethylene oxide condensates, ethoxylated castor oil, polyoxyethylene or polyoxypropylenealkyl ethers, lauryl alcohol polyglycol ether acetate, sorbitol esters, lignin-sulfite waste liquors, or methylcellulose.

It may be useful to add one or more binders to the composition, particularly when the composition is applied in a seed treatment. Preferably, the binder is an adhesive polymer that may be natural or synthetic and does not produce a phytotoxic effect on the seed. Suitable binders include polyvinyl acetates; polyvinyl acetate copolymers; polyvinyl alcohols; polyvinyl alcohol copolymers; celluloses, including ethylcelluloses, methylcelluloses, hydroxymethylcelluloses, hydroxypropylcelluloses and carboxymethylcellulose; polyvinylpyrolidones; polysaccharides, including starch, modified starch, dextrins, maltodextrins, alginate and chitosans; fats; oils; proteins, including gelatin and zeins; gum arabics; shellacs; vinylidene chloride and vinylidene chloride copolymers; calcium lignosulfonates; acrylic copolymers; polyvinylacrylates; polyethylene oxide; acrylamide polymers and copolymers; polyhydroxyethyl acrylate, methylacrylamide monomers; and polychloroprene.

For application to soil, flutriafol may be applied either as a liquid or granular formulation either alone, in mixture, or simultaneously via separate delivery systems, with other pesticides or with fertilizers using a range of machinery, examples of which are given here.

Conventionally, these products are applied in a continuous band along the entire furrow length. Attention has recently been focused on more precise methods that minimize waste and environmental impact as well as targeting more accurately the chemicals at the site. Examples of this technology discussed in the literature are provided below. Each of these methods, used independently or in combination with one another, may be used with this invention.

1. Accurate Applications of Liquids to the Seed Furrow.

See http://sensors.ag.utk.edu/Projects/Online_Publications/Beltwide_Cotton_Conf.pdf, herein incorporated by reference in its entirety. See also, Hancock, J. H., Wilkerson, J. B., Moody, F. H., Hart, W. E. and Newman A. E. (2003), “Seed-specific placement of in-furrow chemicals,”Presented at 2003 ASAE Annual International Meeting, Riviera Hotel and Convention Center, Las Vegas, Nev., USA, 27-30 Jul. 2003, herein incorporated by reference in its entirety.

Hancock et al developed an applicator that applied discrete pulses of liquid chemical to individual seeds at planting. In cotton trials inoculated with a seedling disease, the applicator produced plant stands statistically identical to those produced by conventional fungicide application, while reducing fungicide inputs by 50%.

The design was required to: (1) detect each seed as it passed through the seed tube; (2) track each seed from the point of detection to the point of chemical application; and (3) apply a discrete pulse of chemical spray to each seed and the surrounding soil, as the seed landed in the furrow.

The protoype system consisted of: (1) a seed detection sensor; (2) a seed-tracking circuit; (3) a fluid delivery subsystem; and (4) a text-based user interface. Seed detection was accomplished using a commercially-available seed sensor, as factory-installed on a planter seeding tube. A microcontroller-based (MCU) algorithm was used for seed-tracking. The fluid delivery subsystem was connected to the seed-tracking device and included components necessary to produce spray band lengths of 0.5 to 6 inches at planting speeds up to 6 mph. Seed delay time (time between seed detection and the point of chemical application) and spray pulse width were adjusted using the user interface.

Seed-specific placement of in-furrow fungicides (placing the chemical in a small zone around the seed) reduced chemical inputs by 50%, while providing seedling disease protection equivalent to the conventional, continuous application method. Additionally, the prototype seed-specific applicator developed for this study was accurate across a range of planting conditions, adequately spraying over 80% of seeds at 2, 4, and 6 mph when the spray band length was at least 2 inches.

2. Accurate Application of Granules to the Seed Furrow—SmartBox™.

See http://www.amvacchemical.info/smartbox_benefits.php, herein incorporated by reference in its entirety.

Amvac market an applicator that fits on major types of seed drill. It allows accurate granular pesticide application at low rates while eliminating worker exposure. The system is sold by Amvac as SmartBox™.

It features electronically controlled metering that provides precise application, while adjusting for changes in ground speed monitored by radar. The system is designed to apply as little as a half pound of pesticide per acre accurately, enabling the use of low rate products. A 12-row planter can treat 185 acres on 30″ rows without reloading. A cab-mounted control box offers row-by-row monitoring capability and the applicator can be shut off using these controls. Internal record keeping capability can store information on up to 100 fields, which can be downloaded onto a personal computer.

3. Accurate Application of Granules to the Seed Furrow—Gandy Applicators.

See http://www.suttonag.com/Gandy.html, herein incorporated by reference in its entirety.

Gandy (Sutton Agricultural Enterprises, Inc, 746 Vertin Avenue, Salinas, Calif. USA 93901) market two sizes of applicator for delivery of pesticide granules when mounted on most types of seed drill. They feature cam gauge metering with precise flow rates. Drive can be supplied by the planter drive shaft, or independently by an electric motor. Optional accessories can be used to disperse material in 5-inch, 7-inch, and 10-inch bands.

4. Accurate Application of Granules to the Furrow—John Deere Applicators.

See http://www.deere.com/servlet/com.deere.u90785.productcatalog.view.servlets.ProdCatProduct?tM=FR&pNbr=1780RH, herein incorporated by reference in its entirety.

John Deer MaxEmerge™ XP planters with 1.6 bushel seed hoppers are available with a variety of granular chemical application attachments to allow application of one or more pesticides at the same time. There are two types of metering rollers available and a large polyethylene hopper holds 70 lb. of pesticide. The design minimizes operator exposure.

5. Application of Flutriafol as a Coating to Granular Fertilizer at Sowing Time.

This method of soil application of flutriafol has been widely used in Australia for 20 years. Flutriafol is applied to the fertilizer as a spray as the fertilizer is moved in an auger or rotary applicator similar to a cement mixer. The coated fertilizer is particularly used for control of stripe rust of wheat (Puccinia striiformis) and blackleg (Leptosphaeria maculans) of canola (oilseed rape).

An example of the benefits when applied for control of stripe rust of wheat was reported by Brown et al (Brown, J. S., Hannah, M. and Ballinger, D. J. (1990) “The effect of triazole-coated superphosphate, applied at sowing, on stripe rust and yield of wheat,” Australasian Plant Pathology 19 (3) 79-81, herein incorporated by reference in its entirety.). See also http://www.publish.csiro.au/paper/APP9900079.htm, herein incorporated by reference in its entirety.

An example of the benefits for control of blackleg in canola was reported by Khangura, R. K. and Martin J. (1999), “Chemical control of blackleg disease of canola in Western Australia,” Proceedings of the 10th International Rapeseed Congress, Canberra, Australia, herein incorporated by reference in its entirety. See also http://www.regional.org.au/au/gcirc/3/194.htm, herein incorporated by reference in its entirety.

6. T-Band Application.

T-band application involves the spraying or dropping of the flutriafol material, depending on form of product, after seeding and in a band of a selected width (usually 5-7 inches wide), centered over the open seed furrow and ahead of the row closing device (press wheel is common on many planters). This creates a T-shaped soil treatment, with some vertical to planter in the furrow and some horizontal to planter across the furrow and to either side, at an equal distance from the furrow.

T-band applications can be used for either granular or liquid product, such as the TOPGUARD 1.5 G applied neat or the TOPGUARD 1.04 SC mixed in a volume of water as diluent. Using a T-band application advantageously allows one to reduce the immediate dose of granular product nearby germinating seed. Examples of recommendations for or use of T-band may be found at the following websites: http://www.cppress.com/docs/label/148672.pdf, http://www.amvacchemical.info/aztec_rates.php, http://www.gandy.net/orbit_air.pdf, http://www.cppress.com/docs/LABEL/L48673.PDF, and http://www.cdms.net/ldat/ld149002.pdf.

The devices discussed above could be modified variously to not only treat the seed or seed area directly, but to also treat the area near the seed and area between the seed placements. Treatments in these other areas may allow the use of liquid or granule product application at higher rates while avoiding seeding/early plant vigor problems observed at the higher rates. Of course, using the higher rate would depend on the application site, formulation, and seed time, among other factors.

Flutriafol applications may also be used with fertilizer while avoiding initial and direct seed contact, which can be problematic depending on the fertilizer used. Two methods are discussed below. One method is generally used on common corn practice, the other is specifically used to “offset” methods to avoid seed contact and allow initial germination prior to seedling contact/uptake of fertilizer (and any coincident chemicals applied with a fertilizer). These methods may be useful and successful when applied to soybean treatments to combat rust.

General options for placement of corn fertilizer on seeds is discussed in http://www.extension.umn.edu/distribution/cropsystems/DC7425.html, herein incorporated by reference in its entirety. Specific Two-by-Two Placement or Below-seed Placement is discussed in http://www.soil.ncsu.edu/publications/Soilfacts/AG-439-29/, herein incorporated by reference in its entirety. The later is discussed in more detail below.

Two-by-Two Placement.

The most common starter placement is 2 inches to the side and 2 inches below the kernel at planting. This precision placement method, called 2-by-2 placement, requires specialized equipment generally consisting of either reverse knives, double-disk openers, or coulters with drop tubing behind them. Each of these equipment packages has advantages depending on the tillage system used (for example, no-till planting or conventional tillage).

All 2-by-2 placement units should be mounted in a manner that will allow them to “float” with the planter. Planter bar and unit spacings often make it difficult to install additional fertilizer attachments; thus, many are placed on forward-mounted tool bars. Forward mounting of starter fertilizer equipment decreases the precision of the placement on rough or rolling ground. These mechanical constraints and the expense of application equipment for placement has prompted researchers and producers to try the alternative placement methods, such as below-seed placements.

Below-Seed Placement is Suited for In-Row Subsoiling Units.

When fluid fertilizer materials are used, a drop nozzle or stainless-steel tube can be attached to the subsoil shank with adjustable locking collars that allow a fixed placement at any depth below the seed.

With liquid application units, care should be taken to prevent the liquid fertilizers from adhering to the subsoiler shank. When this occurs, the liquid starter drips down to the subsoiler shoe and is unavailable for early plant growth. Splatter shields can be welded at specified depths on the subsoiler, or a K-3 or K-5 flood nozzle can be mounted on the end of the drop nozzle with a 45-degree elbow directing the nozzle spray away from the subsoiler shank. Either method will prevent the fluid from dripping down to the subsoiler shoe.

When granular fertilizers are used, materials should be allowed to fall freely into the subsoil track from a height 6 inches above the soil surface. Soil movement prevents granular materials from dropping all the way down to the subsoiler shoe. Below-seed placement is generally not as precise as a “floating” 2-by-2 placement or any surface placement because of draft bar movement.

### EXAMPLES

The following examples provide testing protocols for evaluating the use of flutriafol to protect a soybean plant from a foliar disease. Three different methods of treating soybean seeds and/or plants with flutriafol are assessed: seed treatment, in-furrow spray treatment, and in-furrow granular treatment. To identify the optimal concentrations and temporal applications of the treatments in different climatic conditions, each of these tests are performed at various regions throughout the United States. Suitable testing locations include Mississippi, Arkansas, Louisiana, Iowa, and South Dakota, although other regions in the United States where soybean rust could be problematic are also appropriate.

Plant development and disease incidence are evaluated. To evaluate the effect of the flutriafol treatment on soybean plant development, the following criteria are determined and measured: the emergence and early development at two or more time points post-planting, such as VE (emergence) and V1 (first trifoliate), rate as %, stand (number of plants that have sprouted), and qualitative symptoms (such as discoloration, stem distortion, and chemical necrosis); at V3 (third trifoliate), the same criteria discussed for VE and V1 may again be evaluated, as well as additional measurements for height, node interspacing, and stem elongations for growth measurement. For disease incidence, the following criteria are documented and measured: the post-plant day and development stage at onset; the development/duration; the severity of the infections (using the local state university rating scale, such as the Varietal Information Program for Soybeans (VIPS) Disease Evaluation Information, available at http://web.aces.uiuc.edu/VIPS, or that used by the University of Kentucky, available at http://www.ca.uky.edu/agcollege/plantpathology/ext_files/KentuckySoybeanRustSentinelPlotNetwork.doc); % rust-whole plant; % defoliation; % controlled; % controlled 21 days after treatment; final disease severity; % disease at R6 (full seed); the number of days until breakdown of fungicide; the day post-planting harvested; the yield (bushels per acre, % yield increase, moisture content, date measured); and harvested seed size and quality.

The design of the tests involves the following standard plot:

Standard Plot Design

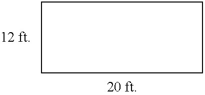

Four rows of soybean plants are planted on spacing in row and between rows. Each of the four rows are subjected to one of the four treatments (two seed treatments, one in-furrow spray treatment, and one in-furrow granular treatment) described in the Examples. An additional four rows of untreated soybeans are planted on spacing in row and between rows in accordance with common local production practice to represent the control. Of the four rows, only the two middle rows are evaluated, as the outside rows are considered more susceptible to edge effects, and thus less reliable.

A. Seed Treatment

Soybean seeds are treated with flutriafol prior to the sowing of the seed. Two different “Straight Product” flutriafol concentrations are used: either 50 grams flutriafol per liter (such as, Vincit 5) and 25 grams flutriafol per liter (such as, Vincit Minima). When using the higher concentration (50 grams flutriafol per liter), the following volumes are applied to the seed (in ml/100 kg seed): 75, 100, 125, 150, 225, 300, and 400. At the lower concentration (25 grams flutriafol per liter), the following volumes of the formulation are applied to the seed (in ml/100 kg seed): 150, 200, 250, 300, 450, 600, and 800. Since the amount of active ingredient used is the same for both concentrations, the final concentration of flutriafol applied to the seed for both the higher and lower concentrations may be expressed as 3.75, 5.00, 6.25, 7.50, 11.25, 15.00, and 20.00 grams flutriafol per 100 kg of seed.

At least 4 fluid oz. of formulation should be used when treating a 50-pound bag of seed to ensure that all seeds are coated. In instances when the volume of Straight Product is less than 4 fluid oz., the flutriafol formulation is diluted with water until the desired total fluid ounces is achieved. For example, 75 ml/100 kg Straight Product at the higher concentration of 50 g/L is equivalent to 0.51 fluid oz./50 lb. bag of seed (1 ml=0.03 fluid oz.; 100 kg=220.5 lbs.; 100 kg=4.4 bags). The 0.51 fluid oz. is therefore diluted with 3.49 fluid oz. of water to reach 4.00 total fluid oz, which is then applied to the 50-lb. bag of seed.

In addition to the specified concentration of flutriafol in the formulations described above, the Vincit® 5 and Vincit® Minima formulations contain propylene glycol, emulsifiers, and other stabilizers and surfactants. Both Vincit® 5 and Vincit® Minima are commercially available from Cheminova A/S.

B. In-Furrow Spray

The soil from which a soybean plant will grow or is growing is treated with an in-furrow spray using IMPACT® 125 SC (125 g flutriafol/L in a suspension concentrate). The following quantities of the formulation are applied to the soil (in terms of fluid oz. of formulation per acre of soil): 3.5, 7, 14, and 27. These formulations may also be expressed as 31.3, 62.5, 125.0, and 250.0 grams flutriafol per hectare of soil, respectively.

In addition to the specified concentration of flutriafol in the formulation, the IMPACT® 125 SC formulation contains emulsifiers, water, C₁₂₋₁₅ ethoxylated alcohols, and other stabilizers and surfactants. IMPACT® 125 SC is commercially available from Cheminova A/S. IMPACT® 125 SC is also marketed as TOPGUARD® 1.04 SC (1.04 pounds flutriafol/gallon).

C. In-Furrow Granular

The soil from which a soybean plant grows is treated with an in-furrow granular testing using IMPACT® 1.5 G (1.5% flutriafol loaded granule). The following amounts of granular formulation are applied to the soil in terms of pounds of product per acre of soil: 1.9, 3.7, and 7.4. The amounts of granular formulation may also be expressed as 31.3, 62.5, and 125.0 g flutriafol per hectare of soil, respectively.

In addition to the specified concentration of flutriafol in the formulation, the IMPACT® 1.5 G formulation contains solid carriers, emulsifiers, stabilizers and surfactants. The most significant difference between IMPACT® 1.5 G and IMPACT® 125 SC lies in product configuration: IMPACT® 125 SC is formulated as suspension concentrate while IMPACT® 1.5 G is formulated as a granular product. IMPACT® 1.5 G is commercially available from Cheminova A/S. IMPACT® 1.5 G is also marketed as TOPGUARD® 1.5 G.

The above examples are run in various locations in the United States to determine the efficacy of protecting a soybean plant from a foliar disease by treating the plant with flutriafol.

### Example 1

The following experiments demonstrate the systemic activity of flutriafol used as a seed- or soil-dressing, to combat Asian Rust (Phakopsora pachyrhizi) in Soy Beans.

Soy bean seed was treated with a range of flutriafol rates, as presented in Table 1 below (right-hand side). Additionally, flutriafol was applied directly to the soil, at the rates described below (left-hand side). Three replicates were done per treatment. At the third trifoliate stage, seedlings where inoculated with rust spores on the ad- and ab-axial surfaces of the third trifoliate.

Following treatments and inoculations, the inoculated plants were transferred to a climate chamber, watered as necessary and evaluated for the incidence of Asian Rust. The average of the recorded incidence of disease (%) on the third trifoliate is presented below. An untreated control is also provided as comparative data.

TABLE 1

| | | |
|---|---|---|
| Dose, soil | | Dose, seed |
| application | Treatment | treatment |

| (g ai/Ha) | Soil | Seed | (ppm) |
|---|---|---|---|
| UTC | 80 | 53 | UTC |
| 3 | 73 | 47 | 3 |
| 10 | 63 | 28 | 10 |
| 30 | 53 | 8 | 30 |
| 100 | 12 | 1 | 100 |
| 300 | 2 | 0 | 300 |
| 1000 | 1 | 0 | 1000 |

UTC = Untreated control

As can be seen from Table 1, the seed treatment with flutriafol and the in-furrow treatment both showed less recorded incidence of disease than the untreated control. Significant improvements were observed in seed treatments using 10 ppm flutriafol or more, especially at 30 ppm or more, and in in-furrow treatments using 30 grams or more flutriafol per hectare, especially 100 grams or more flutriafol per hectare.

### Example 2

A trial in Brazil at Formoso do Araguaia examined the rust control from nine rates of flutriafol applied as a 1.5% granule in a rate range of 4 to 40 kg formulated product per hectare (60 to 600 g flutriafol active ingredient per hectare), three rates of Vincit 2.5% powder seed dressing at 150 to 250 g formulated product per 100 kg seed (2.25 to 3.75 g flutriafol active ingredient per 100 kg seed) and four rates of Vincit 5% SC suspension concentrate seed dressing at 50 to 150 g formulation per 100 kg seed (1.5 to 4.5 g flutriafol active ingredient per 100 kg seed).

These treatments were compared with an untreated and a commercial standard treatment of Derosal Plus, which is a mixture of carbendazim plus thiram in a suspension concentrate formulation applied to seed at a rate of 200 ml formulation per 100 kg seed (30 g thiram plus 70 g carbendazim) per 100 kg seed. Both the untreated sample and the Derosal Plus treatment are provided below as comparative data.

Seed was drilled at 60 kg per hectare in four replicates per treatment. Each replicate consisted of a 6 m row of 100 seeds. With the seed treatments, fertilizer was first applied up to 2 cm below seed depth and then the rows opened to a depth of 3 cm, the seeds sown and the rows closed with soil. In each treatment there were five rows of 6 m length with 45 cm between rows. With the in-furrow treatments, the row was opened using a hoe, and then the appropriate weight amount of Impact 1.5 GR was applied in the row followed directly afterwards with seed placed over the granules. Soil was then placed over the seed to close the row.

Twenty two days after planting, the number of plants emerged was evaluated by counting the emerged seedlings in each of the central three rows of each plot. Disease assessment was done 61 days after emergence by selecting 20 leaves per plot from the whole plant at random, and estimating the percentage rust coverage (% disease severity).

Table 2 presents the results from the trial. All in-furrow treatments controlled the rust, even at the lowest rate of 60 g flutriafol/hectare 61 days after plant emergence. Rates above 150 g flutriafol/hectare gave complete control at this assessment timing. Plant numbers were unaffected by rates up to 300 g flutriafol/hectare and large yield increases were associated with the control of the disease. Rates above 300 g flutriafol per hectare appeared to reduce plant numbers and yield benefits were lower despite complete disease control, suggesting that these rates were phytotoxic to the plants.

All flutriafol seed treatment rates gave reduction in rust but control was lower than with in-furrow treatments. Plant numbers showed that some reduction and yield increases were lower at the higher seed treatment doses, suggesting some phytotoxicity at the higher rates. Derosal Plus showed no significant rust control.

Both methods of application revealed flutriafol rates that were both safe to the crop and were effective in controlling rust for over two months after emergence.

TABLE 2
Control of soybean rust using in-furrow granules of flutriafol
or seed treatments of flutriafol - Formoso do Araguaia, Brazil

| | | | | | Disease | | Yield increase |
|---|---|---|---|---|---|---|---|
| | | Dose of | | Plant | severity (%) | | or reduction |
| | Active | formulated | g | numbers | 61 days after | Yield | (%) versus |
| Product | ingredient | product | AI/ha | emerged | emergence | (kg/ha) | untreated |
| Untreated | | | 0 | 61 | 43 | 2250 | |
| In-furrow | | | | | | | |
| treatments | | | | | | | |
| Impact 1.5 G | Flutriafol | 4 kg/ha | 60 | 57 | 4 | 2990 | 33 |
| Impact 1.5 G | Flutriafol | 6 kg/ha | 90 | 60 | 2 | 2970 | 32 |
| Impact 1.5 G | Flutriafol | 8 kg/ha | 120 | 69 | 2 | 3820 | 70 |
| Impact 1.5 G | Flutriafol | 10 kg/ha | 150 | 56 | 1 | 3260 | 45 |
| Impact 1.5 G | Flutriafol | 12 kg/ha | 180 | 60 | 0 | 3130 | 39 |
| Impact 1.5 G | Flutriafol | 16 kg/ha | 240 | 54 | 0 | 3370 | 50 |
| Impact 1.5 G | Flutriafol | 20 kg/ha | 300 | 63 | 0 | 3640 | 62 |
| Impact 1.5 G | Flutriafol | 30 kg/ha | 450 | 54 | 0 | 2630 | 17 |
| Impact 1.5 G | Flutriafol | 40 kg/ha | 600 | 50 | 0 | 2230 | −1 |

| | | | | | | Disease | | Yield increase |
|---|---|---|---|---|---|---|---|---|
| | | Dose of | Dose of | g AI/ha at | Plant | severity (%) | | or reduction |
| Seed | Active | formulated | AI/100 | a 60 kg/ha | numbers | 61 days after | Yield | (%) versus |
| treatments | ingredient | product | kg seed | rate | emerged | emergence | (kg/ha) | untreated |
| Vincit 2.5 DS | Flutriafol | 150 g/100 kg | 3.75 | 2.25 | 63 | 30 | 3220 | 43 |
| | | seed | | | | | | |
| Vincit 2.5 DS | Flutriafol | 200 g/100 kg | 5 | 3 | 61 | 20 | 3190 | 42 |
| | | seed | | | | | | |
| Vincit 2.5 DS | Flutriafol | 250 g/100 kg | 6.25 | 3.75 | 52 | 16 | 2850 | 27 |
| | | seed | | | | | | |
| Vincit 5% SC | Flutriafol | 50 ml/100 kg | 2.5 | 1.5 | 58 | 32 | 3020 | 34 |
| | | seed | | | | | | |
| Vincit 5% SC | Flutriafol | 75 ml/100 kg | 3.75 | 2.25 | 58 | 17 | 2800 | 24 |
| | | seed | | | | | | |
| Vincit 5% SC | Flutriafol | 100 ml/100 kg | 5 | 3 | 50 | 21 | 2820 | 25 |
| | | seed | | | | | | |
| Vincit 5% SC | Flutriafol | 150 ml/100 kg | 7.5 | 4.5 | 44 | 20 | 2480 | 10 |
| | | seed | | | | | | |
| Derosal Plus | Thiram + | 200 ml/100 kg | 70 + 30 | 42 + 18 | 58 | 41 | 2740 | 22 |
| | Carbendazim | seed | | | | | | |

### Example 3

A greenhouse experiment was performed to demonstrate the systemic activity of Flutriafol used as a soil-dressing. The following experiments demonstrate the systemic activity of Flutriafol used as a seed- or soil-dressing, to combat Asian Rust in Soy Beans.

Soya seed was treated with a range of flutriafol rates, as presented in Table 3 below (right-hand side). Additionally, flutriafol was applied directly to the soil, at the rates described below (left-hand side). Three replicates where made per treatment. At the third trifoliate stage, seedlings where inoculated with rust spores on the ad- and ab-axial surfaces of the third trifoliate.

Following treatments and inoculations, the inoculated plants where transferred to a climate chamber, watered as necessary and evaluated for the incidence of Asian Rust. The average of the recorded incidence of disease on the third trifoliate is presented below.

TABLE 3

Treatment

| Dose | Soil | Seed | Dose |
|---|---|---|---|
| (g ai/Ha) | (28DPI) | (21DPI) | (ppm) |
| UTC | 39 | 49 | UTC |
| 3 | 18 | 31 | 3 |
| 10 | 16 | 35 | 10 |
| 30 | 0 | 40 | 30 |
| 100 | 0 | 0 | 100 |
| 300 | 0 | 0 | 300 |
| 1000 | 0 | 0 | 1000 |

DPI = Days post inoculation/treatment

As can be seen from Table 3, the seed treatment with flutriafol and the in-furrow treatment both showed less recorded incidence of disease than the untreated control. Complete disease control was observed in seed treatments using 100 ppm flutriafol or more and in-furrow treatments using 30 grams flutriafol per hectare or more. Significant improvements in disease control were observed for in-furrow treatments using just 3 grams flutriafol per hectare.

The scope of this invention should not be limited to the preferred embodiments or examples disclosed herein but rather by the claims as set forth below.

We claim:

1. A method of protecting a soybean plant from a foliar disease, the method comprising applying a composition comprising an effective amount of flutriafol to the soil from which a soybean seed grows.

2. The method according to claim 1, wherein the foliar disease is rust disease.

3. The method according to claim 2, wherein the rust disease is caused by Phakopsora pachyrhizi or Phakopsora meibomiae.

4. The method according to claim 1, wherein the composition is applied in an amount ranging from about 2 to about 375 grams flutriafol per hectare of soil.

5. The method according to claim 1, wherein the composition further comprises one or more additional component selected from the group consisting of fertilizers, insecticides, fungicides, and mixtures thereof.

6. The method according to claim 1, wherein the method further comprises applying at least one fertilizer to the soil.

7. The method according to claim 1, wherein the method further comprises applying at least one insecticide to the soil.

8. The method according to claim 7, wherein the insecticide is diazinon or imidacloprid.

9. The method according to claim 1, wherein the method further comprises applying at least one fungicide to the soil.

10. The method according to claim 9, wherein the fungicide is selected from the group consisting of captan, fludioxonil, prochloraz, thiram, carboxin, maneb, mancozeb, pentachloronitrobenzene, metalaxyl, benomyl, thiabendazole, thiophanate-methyl, and carbendazim.

11. The method according to claim 1, wherein the composition is applied in liquid, solid, or granular form.

12. A method of protecting a plant from soybean rust disease, the method comprising applying a composition comprising an effective amount of flutriafol to the soil from which the seed of a plant grows.

13. The method according to claim 12, wherein the plant is selected from the group consisting of legumes, soybean plants, Korean and Japanese clover, white clover, kidney beans, garden pea, and hyacinth bean.

14. The method according to claim 13, wherein the plant is a soybean plant.

15. The method according to claim 12, wherein the soybean rust disease is Phakopsora pachyrhizi or Phakopsora meibomiae.

16. The method according to claim 12, wherein the composition is applied in an amount ranging from about 2 to about 375 grams flutriafol per hectare of soil.

17. The method according to claim 12, wherein the composition further comprises one or more additional component selected from the group consisting of fertilizers, insecticides, fungicides, and mixtures thereof.

18. The method according to claim 12, wherein the method further comprises applying at least one fertilizer to the soil.

19. The method according to claim 12, wherein the method further comprises applying at least one insecticide to the soil.

20. The method according to claim 19, wherein the insecticide is diazinon or imidacloprid.

21. The method according to claim 12, wherein the method further comprises applying at least one fungicide to the soil.

22. The method according to claim 21, wherein the fungicide is selected from the group consisting of captan, fludioxonil, prochloraz, thiram, maneb, mancozeb, pentachloronitrobenzene, metalaxyl, benomyl, thiabendazole, thiophanate-methyl, and carbendazim.

23. The method according to claim 12, wherein the composition is applied in liquid, solid, or granular form.

24. The method according to claim 1, further comprising the step of applying an additional flutriafol composition to the leaves of the resulting soybean plant through a foliar application.

25. The method according to claim 12, further comprising the step of applying an additional flutriafol composition to the leaves of the resulting plant through a foliar application.

26. The method of claim 4, wherein the composition is applied in an amount ranging from about 10 to about 375 grams flutriafol per hectare of soil.

27. The method of claim 26, wherein the composition is applied in an amount ranging from about 30 to about 125 grams flutriafol per hectare of soil.

28. The method of claim 16, wherein the composition is applied in an amount ranging from about 10 to about 375 grams flutriafol per hectare of soil.

29. The method of claim 28, wherein the composition is applied in an amount ranging from about 30 to about 125 grams flutriafol per hectare of soil.

30. The method of claim 1 or claim 12, wherein said applying is done prior to, during, or immediately after the sowing of the seed.

31. A method of protecting a soybean plant from disease caused by a foliar disease comprising: applying a composition to the soil from which a soybean seed grows, said a composition comprising an effective amount of flutriafol, wherein said composition suppresses growth of Phakopsora pachyrhizi or Phakopsora meibomiae.

32. A process comprising: making a soil treatment composition comprising an effective amount of flutriafol, and applying said composition to the soil from which a soybean seed grows, wherein said composition is applied in an amount ranging from about 10 to about 375 grams flutriafol per hectare of soil.

33. A method for controlling a foliar disease caused by Phakopsora pachyrhizi or Phakopsora meibomiae, the method comprising applying a composition to the soil from which a soybean seed grows with an effective amount of a composition comprising an effective amount of flutriafol, said treating resulting in the control of said foliar disease.

34. A method for increasing the yield of a soybean plant, the method comprising protecting said soybean plant according to the method of claim 1, and harvesting the resultant soybean seed from said soybean plant.

35. A soybean plant, or parts thereof, produced by the method of claim 1.

36. A method for producing a soybean seed, the method comprising protecting a soybean plant from a foliar disease according to the method of claim 1, and harvesting the resultant soybean seed from said soybean plant.

37. A soybean seed produced by the method of claim 36.

38. A soybean plant, or parts thereof, produced by growing a seed produced by the method of claim 36.

39. A flutriafol composition for protecting a soybean plant from a foliar disease, wherein said composition is applied to the soil from which a soybean seed grows in order to protect a soybean plant grown in the soil to which the composition had been applied, said composition comprising an effective amount of flutriafol.
